(19) United States
(12) Patent Application Publication
(10) Pub. No.: US 2007/0139364 A1
(43) Pub. Date: Jun. 21, 2007

(54) PORTABLE INPUT DEVICE WITH A FUNCTION OF DISPLAYING A PERSONAL FAVORITE COMPUTER ENVIRONMENT FOR USER

(76) Inventors: Xiao-Guang Li, Shenzhen (CN); Kuan-Hong Hsieh, Shenzhen (CN); Wen-Chuan Lian, Shenzhen (CN); Han-Che Wang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/309,335

(22) Filed: Jul. 27, 2006

(30) Foreign Application Priority Data
Dec. 21, 2005 (CN) 200510121011.6

(51) Int. Cl. G09G 5/00

(52) U.S. Cl. 345/156

(57) ABSTRACT

A preferred embodiment of a method of this invention includes the steps of: connecting the portable input device to a computer; changing a configuration pointer of the computer from pointing to computer configuration data of the computer to pointing to a selected computer configuration data of the portable input device, and, simultaneously, changing a disk pointer of the computer from pointing to a main data storage of the computer to pointing to a data storage of the portable input device; obtaining the selected computer configuration data and at least one predetermined folder; changing the configuration data pointer of the computer from pointing to the computer configuration data of the portable input device to pointing to the preferred computer configuration data of the computer, and simultaneously, resetting the disk pointer of the computer when the connection between the computer and the portable input device is disabled.

### FIELD OF THE INVENTION

The present invention generally relates to a portable input device with a function of displaying a personal favorite computer environment for user.

### DESCRIPTION OF RELATED ART

Computers have become necessary tools in people's daily lives, and have become the preferred choice to when it comes to storing information. Storing information in a computer allows the information to be more easily shared and distributed.

Users operate computers in different places such as at home or at work. Users may also choose to use shared computers not belonging to them when their own computers are not accessible. Using the shared computer would mean accessing the system thereof, thus jeopardizing the security of the data stored within. Additionally, when using the shared computer, the computer environment set up may not be that of the user's favorite computer environment.

By using an external hard disk, a user may use a hard disk tray to couple the external hard disk into another computer's hard disk bay. The system configuration stored in the external hard drive would allow using the resources of the other computer's without accessing the data stored within. However, one shortcoming of the removable external hard disk is that it is too expensive and too heavy resulting in inconvenience when carrying it. Another shortcoming of the external hard drive is that the computer that uses it must have a hard disk bay itself, and this is not common.

A notebook could also solve the above problem but it is even more expensive and heavier.

What is needed is a portable input device which has less weight and less cost, allowing a user to use a shared computer's resources without accessing the data, and setting up a preferred computer environment accustomed to the user.

### SUMMARY OF INVENTION

A portable input device with a function of displaying a personal favorite computer environment for user is provided. A preferred embodiment of the portable input device includes a transmitting interface, a microcontroller unit, and a data storage. The transmitting interface is for performing a data communication between a computer and the portable input device. The data storage is for storing a preferred computer configuration data, “my folders”, and an application program. The microcontroller unit being connected to the transmitting interface and the data storage is for controlling the data communication between the portable input device and the computer. The application program includes an operation module and a pointer reset module. The operation module is for changing a configuration pointer of the computer from pointing to a computer configuration data of the computer to pointing to the preferred computer configuration data of the portable input device, simultaneously changing a disk pointer of the computer from pointing to a main data storage of the computer to pointing to the data storage of the portable input device respectively, and accessing the data storage of the portable input device to obtain the preferred computer configuration data and “my folders” according to the configuration pointer of the computer. The pointer reset module is for changing the configuration data pointer from pointing to the preferred computer configuration data of the portable input device to pointing to the computer configuration data of the computer, simultaneously, resetting the disk pointer from the data storage of the portable input device to the main data storage of the computer, when the connection between the computer and the portable input device is disabled.

A method for implementing a portable input device with a function of displaying a personal favorite computer environment for user is provided. A preferred embodiment of the method includes: connecting the portable input device to a computer; changing a configuration pointer of the computer from pointing to computer configuration data of the computer to pointing to a selected computer configuration data of the portable input device, and, simultaneously, changing a disk pointer of the computer from pointing to a main data storage of the computer to pointing to a data storage of the portable input device; accessing the data storage to obtain the selected computer configuration data and at least one predetermined folder according to a path pointed by the configuration pointer of the computer; operating general operation of the computer by receiving operation instructions and cursor position recognition instructions input by the portable device; changing the configuration data pointer of the computer from pointing to the computer configuration data of the portable input device to pointing to the preferred computer configuration data of the computer, and simultaneously, resetting the disk pointer of the computer from the data storage of the portable input device to the main data storage of the computer, when the connection between the computer and the portable input device is disabled.

Other advantages and novel features will be drawn from the following detailed description of exemplary embodiments with reference to the attached drawings, in which:

### BRIEF DESCRIPTION OF DRAWINGS

FIG. 1 is a block diagram of a preferred embodiment linking a portable input device and a computer in accordance of the present invention;

FIG. 2 is a schematic diagram of main function modules of the application program of FIG. 1; and

FIG. 3 is a flow chart of a preferred method for implementing data communication between the portable input device and the computer of FIG. 1, utilizing the application program.

### DETAILED DESCRIPTION

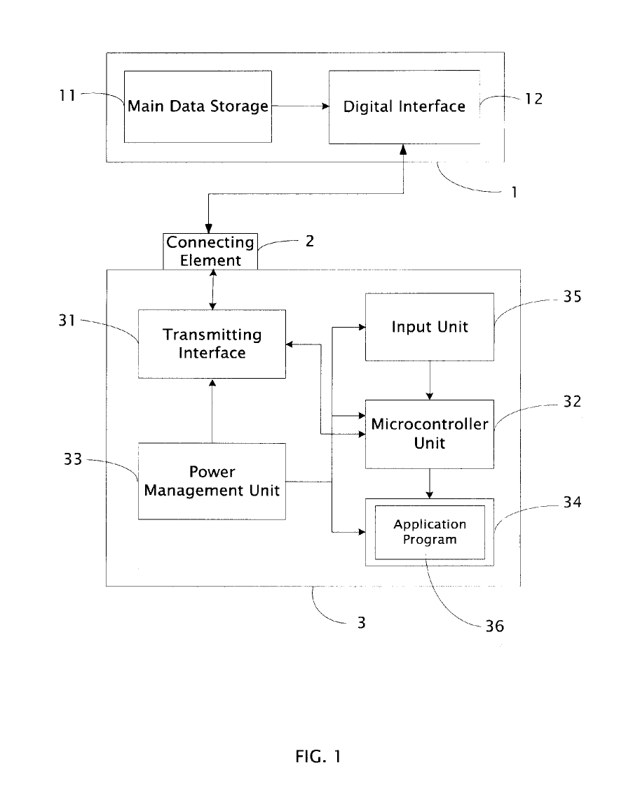

FIG. 1 is a block diagram of a preferred embodiment linking a portable input device and a computer in accordance of the present invention. The portable input device 3 connects to the computer 1 and configures a preferred computer environment for operating the portable input device 3. The computer 1 includes a main data storage 11 and a digital interface 12. The main data storage 11 has a driver therein for driving the portable input device 3. The digital interface 12 provides an interface for connecting the portable input device 3 thereto. Additionally, the portable input device 3 provides a connecting element 2 to connect with computer 1. The connecting element 2 is also of a digital interface. The connecting element 2 could be separated from or incorporated within the portable input device 3. For simplicity, in such case, the former (such as that shown in FIG. 1) is adopted.

The portable input device 3 (e.g., mouse) includes a transmitting interface 31, a microcontroller unit 32, a power management unit 33, a data storage 34, and an input unit 35.

crocontroller unit 32 is for receiving operation instructions and cursor position recognition instruction inputs by the input unit 35, and for controlling data communication between the main data storage 11 of the computer 1 and the data storage 34 of the portable input device 3.

Under the control of the microcontroller unit 32, the transmitting interface 31 either receives data from the main data storage 11 or outputs data from the data storage 34 through the digital interface 12 and the connecting element 2, thereby performing data communication.

The power management unit 33 supplies power to the transmitting interface 31, the microcontroller unit 32, the data storage 34, and the input unit 35.

The data storage 34 is for storing a preferred computer configuration data, “my folders”, and an application program 36. The preferred computer configuration data includes preferred computer environment configuration data and general applications configuration data. The general applications can be such as, for example, Microsoft Word, Microsoft Excel, and so on. The computer environment configuration data is for setting a preferred computer environment that a user of the portable input device is familiar. The general applications configuration data is for setting general applications according to the user's personal preference. “my folders” is for storing important or frequently used data. “my folders” can be such as, for example, my favorite folder, “my document” folder of a windows operation system, and/or some other user-defined folder.

The application program 36 automatically installs into the computer 1 once the portable input device 3 is connected to the computer 1 and automatically uninstalls from the computer 1 when the connection between the computer 1 and the portable input device 3 is disabled. The application program 36 may also be downloaded from a network sever once the portable input device 3 is connected to the computer 1 and automatically uninstalls from the computer 1 when the connection between the computer 1 and the portable input device 3 is disabled.

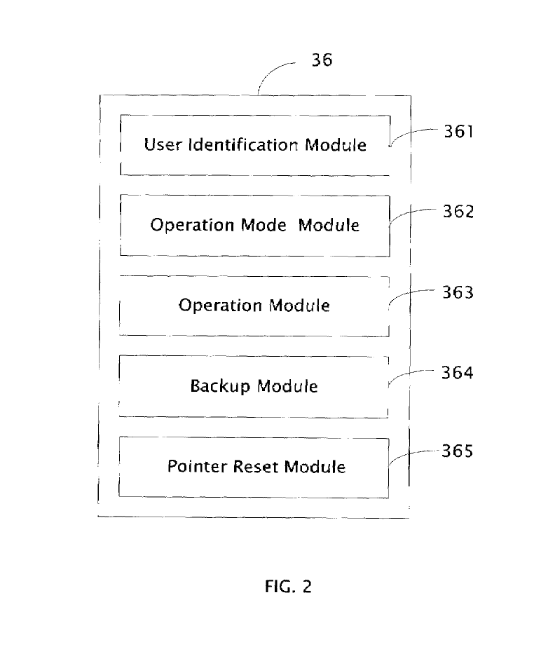

FIG. 2 is a schematic diagram of function modules of the application program 36. The application program 36 includes a user identification module 361, an operation mode module 362, an operation module 363, a backup module 364, and a pointer reset module 365.

The user identification module 361 is for determining whether the user operating the portable input device 3 is an authorized user through a password authentication system. The user identification module 361 further provides a dialog box in a display device of the computer 1 for the user to input a valid user name and a valid password when the portable input device 3 is connected to the computer 1. The user identification module 361 rejects access to the data of the portable input device 3 if the username or the password inputted is not correct, thereby enhancing the security of the data thereof.

The operation mode module 362 is for determining an operation mode of the computer 1 according to the user's choice. The operation mode includes a host mode and a client mode. The host mode is provided for the user who has a password authentication and can enter the system of the computer 1, such as the host of the computer 1. The client mode is provided for the user who has not a password authentication and cannot enter the system of the computer 1. The operation module 363 is for controlling the communication between the computer 1 and the portable input device 3. For example, if the operation mode of the computer 1 is in the client mode, the computer 1 changes a configuration data pointer of the computer 1 from pointing to a computer configuration data of the computer 1 to pointing to the preferred computer configuration data of the portable input device 3. The computer configuration data includes the computer environment configuration data and the general applications configuration data. Simultaneously, the computer 1 changes a disk pointer of the computer 1 from pointing to the main data storage 11 of the computer 1 to pointing to the data storage of the portable input device 3, thereby shielding the main data storage 11 of the computer 1 from being accessed.

Accordingly, the computer 1 directly accesses the data storage 34 to obtain the preferred computer configuration data and “my folders” according to addresses pointed by the configuration data pointer and the disk pointer of the computer 1, thus configuring the preferred computer environment according to the preferred computer environment configuration data. Therefore, the user can operate on the computer 1 in a personal preferred computer environment. The input unit 35 receives the operation instructions and cursor position recognition instructions for general operations such as reading, writing, or modifying data on the computer 1, if necessary.

The backup module 364 is for operating the input device 3 in the host mode. The user can save documents from the computer 1 to the portable input device 3 as “my folders” and can also backup documents from the portable input device 3 to the computer 1.

The pointer reset module 365 is for resetting addresses pointed by the configuration data pointer and the disk pointer of the computer 1 when the connection between the computer 1 and the portable input device 3 is disabled. That is, the pointer reset module 365 changes the configuration data pointer of the computer 1 from pointing to the preferred computer configuration data of the portable input device 3 to pointing to the computer configuration data of the computer 1. Simultaneously, the pointer reset module 365 changes the disk pointer of the computer 1 from the data storage 36 to the main data storage 11.

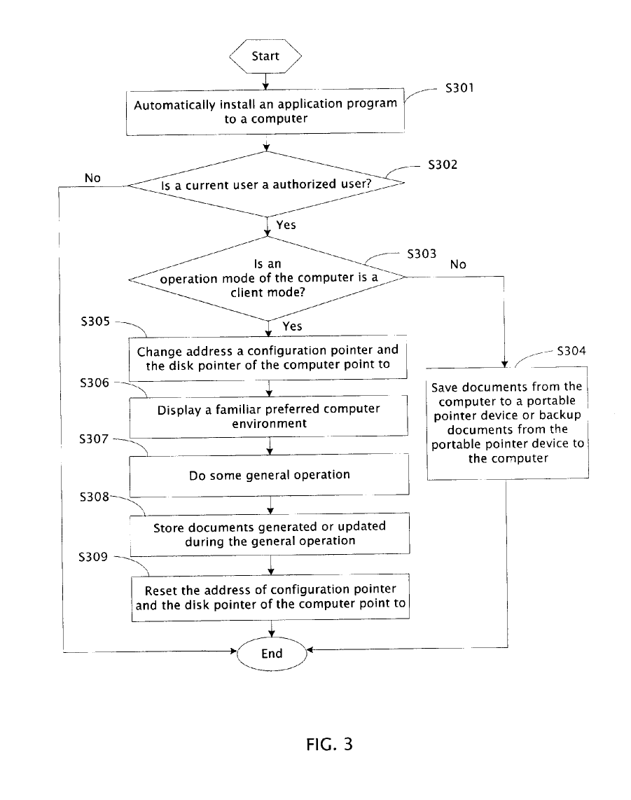

FIG. 3 is a flow chart of a preferred method of implementing the data communication between the computer 1 and the portable input device 3 utilizing the application program 36. In step S301, the application program 36 automatically installs itself into the computer 1 once the computer 1 is connected to the portable input device 3.

In step S302, the user identification module 361 determines whether the user operating on the portable input device 3 is the authorized user of the portable input device 3 according to the user name and the password inputted.

In step 303, the operation mode module 362 determines whether the operation mode of the computer 1 is the client mode or the host mode according to the user's selection.

In step 304, if the operation mode of the computer 1 is the host mode, the user is allowed to save documents from the computer 1 into the portable input device 3 as “my folders” and is also allowed to backup documents from the portable input device 3 into the computer 1.

In step 305, if the operation mode of the computer 1 is in the client mode, the computer 1 changes the configuration pointer of the computer 1 from pointing to the computer configuration data of the computer 1 to pointing to the preferred computer configuration data of the portable input device 3, and, simultaneously, changes the disk pointer of the computer 1 from pointing to the main data storage 11 of the computer 1 to pointing to data storage 36, thereby shielding the main data storage 11 of the computer 1 from being accessed.

In step 306, the computer 1 directly accesses the data storage 36 to obtain the preferred computer configuration data and “my folders” according to the address pointed by the configuration pointer and disk pointer of the computer 1, and thus to display the personal preferred computer environment for the user according to the preferred computer environment configuration data.

In step S307, the input unit 35 receives the operational instructions and cursor position recognition instructions for general operations such as reading, writing, or modifying data on the computer 1, if necessary.

In step 308, documents generated or updated by general operations are stored to data storage 34 of the portable input device 3.

In step 309, when the connection between the computer 1 and the portable input device 3 is disabled, the pointer reset module changes the configuration pointer and the disk pointer of the computer 1 to point to the address of the computer configuration data and the main data storage of the computer 1 respectively.

Although the present invention has been specifically described on the basis of a preferred embodiment, the invention is not to be construed as being limited thereto. Various changes or modifications may be made to the embodiment without departing from the scope and spirit of the invention.

What is claimed is:

1. A portable input device with a function of displaying a selected computer environment for a user, comprising:
a transmitting interface for performing data communications between a computer and the portable input device;
a data storage for storing computer configuration data, a selected folder, and an application program; and
a microcontroller unit, connected to the transmitting interface and the data storage, for controlling the data communications between the portable input device and the computer;
wherein the application program comprises:
an operation module for changing a configuration pointer of the computer from pointing to a selected computer configuration data of the computer to pointing to the selected computer configuration data of the portable input device, simultaneously changing a disk pointer of the computer from pointing to a main data storage of the computer to pointing to the data storage of the portable input device respectively, and accessing the data storage of the portable input device to obtain the selected computer configuration data and the selected folder according to the configuration pointer of the computer; and
a pointer reset module for changing the configuration data pointer from pointing to the selected computer configuration data of the portable input device to pointing to the computer configuration data of the computer, simultaneously, resetting the disk pointer from the data storage of the portable input device to the main data storage of the computer when the connection between the computer and the portable input device is disabled.

2. The portable input device as described in claim 1, wherein, the selected computer configuration data comprises a selected computer environment configuration data for setting a personal favorite computer environment for the user.

3. The portable input device as described in claim 1, wherein, the selected computer configuration data further comprises a general applications configuration data for setting general applications according to users'; personal preference.

4. The portable input device as described in claim 1, wherein the selected folder is a backup of data from the computer.

5. The portable input device as described in claim 1, wherein the application program further comprises a user identification module for determining whether a user operating on the portable input device is an authorized user through a password authentication system.

6. The portable input device as described in claim 1, wherein the application program further comprises a backup module for saving documents from the computer to the selected folder of the portable input device and saving back-up documents from the portable input device into the computer.

7. The portable input device as described in claim 1, wherein the computer is selectively to work in one of two operation modes which are a client mode and a host mode.

8. The portable input device as described in claim 7, wherein, the application program further comprises an operation mode module for determining an operation mode of the computer according to the inputted selection.

9. A method for implementing a portable input device with a function of displaying a selected computer environment for a user, comprising the steps of:
connecting the portable input device to a computer;
changing a configuration pointer of the computer from pointing to computer configuration data of the computer to pointing to a selected computer configuration data of the portable input device, and, simultaneously, changing a disk pointer of the computer from pointing to a main data storage of the computer to pointing to a data storage of the portable input device;
accessing the data storage to obtain the selected computer configuration data and at least one predetermined folder according to a path pointed by the configuration pointer of the computer;
operating general operation of the computer by receiving operation instructions and cursor position recognition instructions input by the portable device;
changing the configuration data pointer of the computer from pointing to the computer configuration data of the portable input device to pointing to the preferred computer configuration data of the computer, and simultaneously, resetting the disk pointer of the computer from the data storage of the portable input device to the main data storage of the computer, when the connection between the computer and the portable input device is disabled.

10. The method as described in claim 9, wherein, the selected computer configuration data comprises a selected computer environment configuration data for setting a selected computer environment for the user.

11. The method as described in claim 9, wherein, the selected computer configuration data further comprises a general applications configuration data for setting general applications.

12. The method as described in claim 9, wherein, the at least one predetermined folder is a backup of selected data from the computer.

13. The method as described in claim 9, wherein, the computer is selectively to work in one of a client mode and a host mode.

14. The method as described in claim 9, further comprising the step of determining whether the user is an authorized user after connecting the portable input device to a computer.

15. The method as described in claim 14, further comprising the step of determining an operation mode of the computer before changing a configuration pointer of the computer.

16. A portable input device comprising:
a transmitting interface for performing data communications with a computer;
a data storage for storing selected computer configuration data and a selected folder; and
a microcontroller unit, connected to the transmitting interface and the data storage, for controlling data communications between the portable input device and the computer; and
an operation module programmed for changing a configuration pointer of the computer from pointing to a computer configuration data of the computer to pointing to the selected computer configuration data of the portable input device, simultaneously changing a disk pointer of the computer from pointing to a main data storage of the computer to pointing to the data storage of the portable input device respectively, and accessing the data storage of the portable input device to obtain the selected computer configuration data and the selected folder according to the configuration pointer of the computer.

17. The portable input device as described in claim 16, further comprising a pointer reset module programmed for changing the configuration data pointer from pointing to the selected computer configuration data of the portable input device to pointing to the computer configuration data of the computer, simultaneously, resetting the disk pointer from the data storage of the portable input device to the main data storage of the computer when the connection between the computer and the portable input device is disabled.

18. The portable input device as described in claim 16, further comprising a user identification module programmed for determining whether a user operating on the portable input device is an authorized user through a password authentication system.

19. The portable input device as described in claim 16, further comprising a backup module for saving documents from the computer to the selected folder of the portable input device and saving back-up documents from the portable input device into the computer.
